(19) United States
(12) Patent Application Publication
(10) Pub. No.: US 2015/0220645 A1
(43) Pub. Date: Aug. 6, 2015

(54) EWS Optimized Paged Item Loading

(71) Applicant: CHECK POINT SOFTWARE TECHNOLOGIES LTD., Tel Aviv (IL)

(72) Inventor: Yuval RABAN, Rehovot (IL)

(73) Assignee: CHECK POINT SOFTWARE TECHNOLOGIES LTD., Tel Aviv (IL)

(21) Appl. No.: 14/173,837

(22) Filed: Feb. 6, 2014

(51) Int. Cl. G06F 17/30; H04L 29/08

(52) U.S. Cl. CPC G06F 17/30867; H04L 67/02

(57) ABSTRACT

A system for optimized paged item loading in Exchange Web Services (EWS) improves response time of user queries to EWS. In contrast to conventional implementations that search an entire folder first, and then present results to user, this invention features not searching the entire folder, but searching only portions of the folder and then only searching portions until a desired number of results is obtained. Folders are sampled in an interval of N items and then using an abstract paging mechanism, thus defining a new restricted page with a limited item count of N. The sampling is performed in a first operation, for example, by using FindItem. In a second operation, FindItem is again used with a requested restriction, which is limited to the restricted page according to the samples. Searches may be limited by the amount of items to return or results (result set) desired.

### FIELD OF THE INVENTION

The present invention generally relates to Exchange Web Services (EWS), and in particular, it concerns optimized paged item loading.

### BACKGROUND OF THE INVENTION

Exchange Web Services (EWS) API provides clients with easy access to data on an Exchange Server. Specifically, EWS provides an Application Programming Interface (API) to locate items in folders. One API commonly known operation is “FindItem”. The FindItem operation searches for items that are located in an Exchange database, for example, a user's mailbox. The FindItem operation provides many ways to filter and format how search results are returned to the caller (user initiating the command). However, when large data sets are queried for specific items, or large item sets, EWS, even with the FindItem operation is too slow for users. In other words, the user requirements and/or expectations for the time between initiating a search and receiving results of the search are longer than desired.

FindItem provides an ability to search for items answering specific criterions, also known as restrictions. FindItem provides a paging mechanism. However, FindItem performs a full scan on the Exchange Server of an entire folder to find all data relevant to the restriction, after which the paging mechanism is installed to interface with a client to serve a client request. Thus, using a given restriction and/or paging mechanism on large data sets to locate items may prove too slow for users.

The operation “SearchFolder” has also been used to search data components and data stores. However, these initiated SearchFolder requests are not sufficient when requiring quick responses from Exchanges (Exchange Servers). This is due to a random order folder population, not having any indications when the population is complete, and the population over large data sets may take minutes, which is too long for user expectations.

There is therefore a need for a method and system to improve response time of user queries to EWS.

### SUMMARY

According to the teachings of the present embodiment there is provided a method for searching an Exchange Web Services (EWS) server, including the steps of: sending at least one first request to the EWS, each first request including a designator to a corresponding folder and a sample item; receiving at least one sample, each sample corresponding to each first request; defining at least one restricted page, each restricted page corresponding to each sample; sending at least one second request to the EWS, each second request: corresponding to each sample, including the restricted page, and including a search criteria; and receiving results for each second request.

In an optional embodiment, the sending is done using a FindItem command. In another optional embodiment, the sending to the EWS at least one second request is sequential. In another optional embodiment, after the sending to the EWS at least one second request, a decision to send to the EWS a subsequent second request is based on receiving results.

Another optional embodiment, further includes a step of: checking if a total number of received results is greater than or equal to a desired number of results: if yes, returning all the results; and if no, checking if more of at least one second request has not been sent to the EWS: if yes, sending to the EWS a subsequent second request of the at least one second request and continuing at the step of receiving results for each second request; and if no, checking if more first requests can be sent to the EWS: if no, returning all the results; and if yes, sending at least one new first request to the EWS and continuing at the step of receiving at least one sample.

According to the teachings of the present embodiment there is provided a system including: a client configured for: sending at least one first request to the EWS, each first request including a designator to a corresponding folder and a sample item; receiving at least one sample, each sample corresponding to each first request; defining at least one restricted page, each restricted page corresponding to each sample; sending at least one second request to the EWS, each second request: corresponding to each sample, including the restricted page, and including a search criteria; and receiving results for each second request.

In an optional embodiment, the client is further configured to perform the sending using a FindItem command. In another optional embodiment, the client is further configured to perform the sending at least one second request to the EWS sequentially. In another optional embodiment, the client is further configured that after the sending to the EWS the at least one second request, a decision to send to the EWS a subsequent second request is based on receiving results.

In an optional embodiment, the client is further configured for: checking if a total number of received results is greater than or equal to a desired number of results: if yes, returning all the results; and if no, checking if more of at least one second request has not been sent to the EWS: if yes, sending to the EWS a subsequent second request of the at least one second request and continuing at the step of receiving results for each second request; and if no, checking if more first requests can be sent to the EWS: if no, returning all the results; and if yes, sending at least one new first request to the EWS and continuing at the step of receiving at least one sample.

According to the teachings of the present embodiment there is provided a computer-readable storage medium having embedded thereon computer-readable code for searching an Exchange Web Services (EWS) server, the computer-readable code including program code for: sending at least one first request to the EWS, each first request including a designator to a corresponding folder and a sample item; receiving at least one sample, each sample corresponding to each first request; defining at least one restricted page, each restricted page corresponding to each sample; sending at least one second request to the EWS, each second request: corresponding to each sample, including the restricted page, and including a search criteria; and receiving results for each second request.

According to the teachings of the present embodiment there is provided a computer program that can be loaded onto a server connected through a network to a client computer, so that the server running the computer program constitutes an Exchange server in a system according to any of the above claims.

According to the teachings of the present embodiment there is provided a computer program that can be loaded onto a computer connected through a network to a server, so that the computer running the computer program constitutes a client computer in a system according to any of the above claims.

### BRIEF DESCRIPTION OF FIGURES

The embodiment is herein described, by way of example only, with reference to the accompanying drawings, wherein:

FIG. 1 is a diagram of an exemplary environment in which the present invention can operate and basic operation of the current embodiment.

FIG. 2 is a flowchart of an embodiment of a method for optimized paged item loading in EWS.

FIG. 3 is a diagram of an exemplary implementation of FIG. 2.

FIG. 4 is a first exemplary implementation of searching mail items.

FIG. 5 is second exemplary implementation of searching calendar items.

FIG. 6 is a high-level partial block diagram of an exemplary system configured to implement a client or Exchange server.

### DETAILED DESCRIPTION

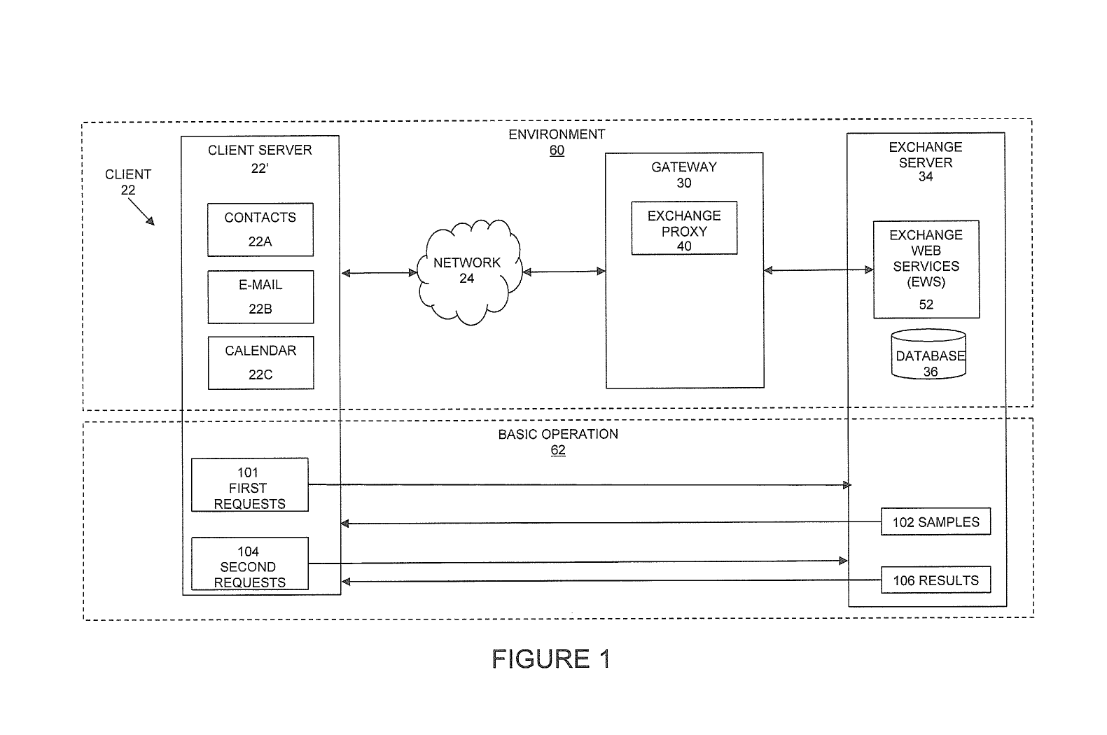

### FIGS. 1 to 6

The principles and operation of the system and method according to a present embodiment may be better understood with reference to the drawings and the accompanying description. A present invention is a system for optimized paged item loading in Exchange Web Services (EWS). The system facilitates improve response time of user queries to EWS.

In general, folders are sampled in an interval of N items, then a new restricted page is defined with a limited item count of N. The sampling is performed in a first operation, for example, by sending a first request using FindItem, also known as a FindItem operation, query, FindItem query, or FindItem request, the terms used interchangeably in this document.

In a second operation that follows the aforementioned first operation, a second request using FindItem, is performed, with requested restrictions of the restricted page and a search criteria. In other words, the second request is limited to the restricted page. An empty search criterion can be used to return all items within a restricted page. Searches may be limited by the amount of items to return or results (result set) desired. This is typically performed by querying a predetermined number of items ahead, and searching the processed pages. If the result set is not at capacity (the desired number of results has not been met), the process is repeated, for example, by querying the next predetermined number of items using first requests, and issuing out additional second requests with restricted pages for the desired items or results.

In contrast to conventional implementations that search an entire folder first, and then present results to user, a feature of the current embodiment is not searching the entire folder, but searching only portions of the folder and then only searching portions until a desired number of results is obtained.

In the context of this document, the term “sample” generally is used for clarity to refer to the results returned from a first request.

In the context of this document, the term “results” generally is used for clarity to refer to the results returned from a second request.

In the context of this document, the term “page” generally refers to a restriction based on a sample and used in a second request as a boundary for the second request.

In the context of this document, the term “server” generally refers to a remote computer or computer device, or remote computer system, or computer program therein, that is accessible over a communications medium, such as the Internet, that provides services to other computer programs and/or servers (and the users of these other computer programs and/or servers), in the same or other computers.

In the context of this document, the term “engine” generally refers to a program or algorithm that performs a core or essential function for other programs. An engine can be a central or focal program in an operating system, subsystem, or application program that coordinates overall operation of other programs. The term engine is also used to describe a special-purpose program containing an algorithm that can sometimes be changed.

In the context of this document, the terms “N” and “S” indicate the last members of a finite series or a potentially changing series, the series including one or more members. In the below non-limiting examples, generally:
N is sample size;
S is the number of samples;
i is the sample number; and
Si is a specific sample, sample number i;

FIG. 1 is a diagram of an exemplary environment 60 in which the present invention can operate and basic operation 62 of the current embodiment. The environment 60 includes a client 22 (client computer), represented by the client server 22′, which links to a communications network 24, such as an organizations internal wired/wireless network, wide area network (WAN), or public network, for example, the Internet. Client server 22′ is generally implemented as software on client 22 that implements the user application or component. Client server 22′ is also referred to in the context of this document for simplicity as “client”. Based on the context of use, one skilled in the art will understand to which component is being referred. A gateway (GW) 30 links to the network 24, and an Exchange server 34 (network server). The Exchange server 34 may be structured to include Exchange Web Services (EWS) module 52 and a database (DB) 36. Exchange server 34 is generally a network server, running one or more applications, one or more processors centrally located, distributed, or implemented in the cloud. Database 36 is shown as a component of Exchange server 34, however one skilled in the art will realize that other implementations for database 36 are possible. The EWS module is generally a server that complies/implements the EWS API, a typical example of which is a Microsoft Exchange Server that complies/implements the EWS API (a Microsoft protocol).

The client server 22′ represents the client 22, typically including an application or component that desires items from the EWS 52. The client 22 can include various processors, including those in a central processing unit (CPU), and including microprocessors, for performing the client server 22′ functions and operations detailed herein, and storage media, either internal or associated therewith. The client server 22′ also includes applications, components and/or modules, collectively “components,” for example, for contacts 22A, e-mail 22B, calendar functions 22C, and tasks. These client server components 22A-22C are, for example, corresponding components of Microsoft® Outlook®. Client application components (for example, contacts 22A, e-mail 22B, and calendar functions 22C) reside on the client 22 and access corresponding data stored on the Exchange server 34 (or more generally in an associated storage, such as database 36). While a single client server 22′ is shown, the client server 22′ may be formed of multiple servers and/or components. A component makes at least one request 101 (the request is typically issued from the client server 22′), which is processed in accordance with the present embodiment.

The gateway 30 is typically a computerized device, and includes an Exchange proxy 40. The gateway 30 provides credentials to each request, upon receiving each request, and sends each now-credentialed request to the Exchange server 34 for processing. The Exchange proxy 40 functions to perform proxying of Exchange Web Services requests, as well as handle the requests' required authentication process. While the gateway 30 is shown as a single device for clarity, gateway 30 can be formed of multiple computerized devices.

The Exchange server 34 handles requests from the client 22, which the Exchange server receives with credentials, via the gateway 30. The Exchange server 34 includes an Exchange Web Services (EWS) protocol module 52 (referred to in this document simply as “EWS”) for providing the functionality to enable client applications to communicate with the Exchange server 34. The Exchange server 34 includes various processors, including those in a central processing unit (CPU), and including microprocessors, for performing the server functions and operations detailed herein, and storage media, either internal or associated therewith. While a single Exchange server 34 is shown, the Exchange server 34 may be formed of multiple servers and/or components.

At a high level, a basic operation 62 of the current embodiment starts with a component on client 22 making at least one request, shown as first requests 101, typically making several requests in parallel. Based on each request, the server, represented by the Exchange server 34 (specifically EWS 52) processes the first requests 101 and returns results for each first request (typically in parallel). The results of first requests are referred to as samples 102 corresponding to the first requests 101. In other words, folders are sampled in intervals, typically using the FindItem operation. The client 22 receives the samples 102, and defines restricted pages, each of the restricted pages (or simply pages) based one of the returned samples 102, thus defining a restriction to the interval of sampling. Second requests 104 are sent from the client 22 to the EWS 52 (typically using a FindItem command). Each second request is typically sent sequentially. Each second request includes restrictions of a restricted page and a search criterion. The EWS 52 receives each second request and processes the request. Processing each second request includes examining (searching), based on the restricted page, a corresponding area of the database 36 for matches to the search criteria. The results 106 of the examination are returned from the EWS 52 to the client 22. On the client 22, the results 106 are processed, and the client 22 makes a decision to send a next page for examination, send additional sampling requests, or to end and return data to the component on client 22 that initiated the requests. The detailed operation of the system is described below.

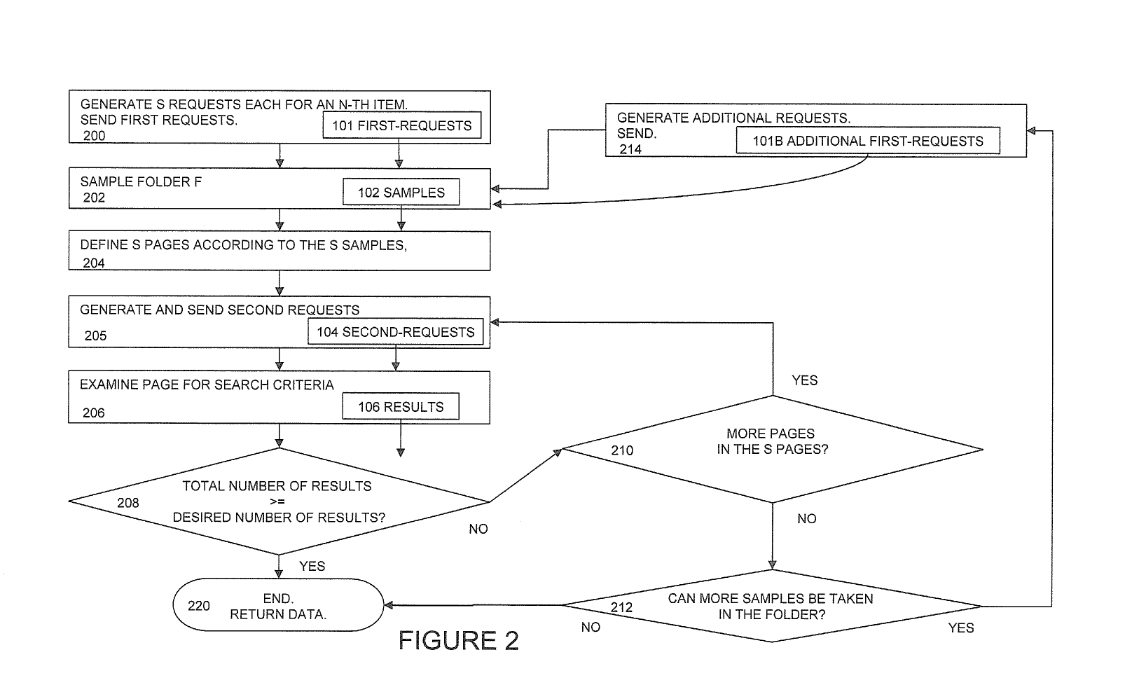

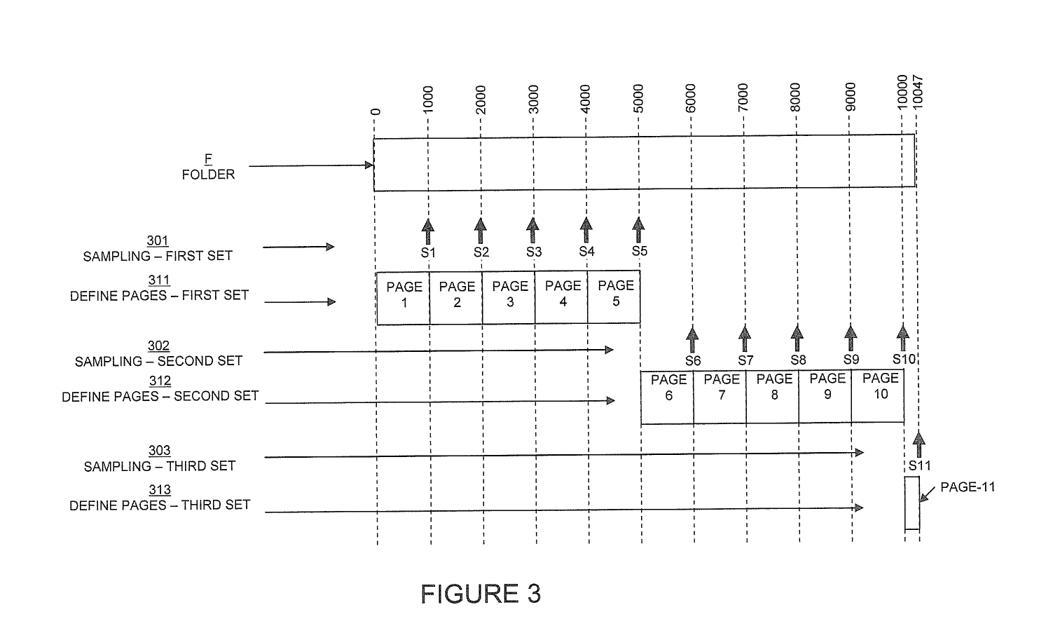

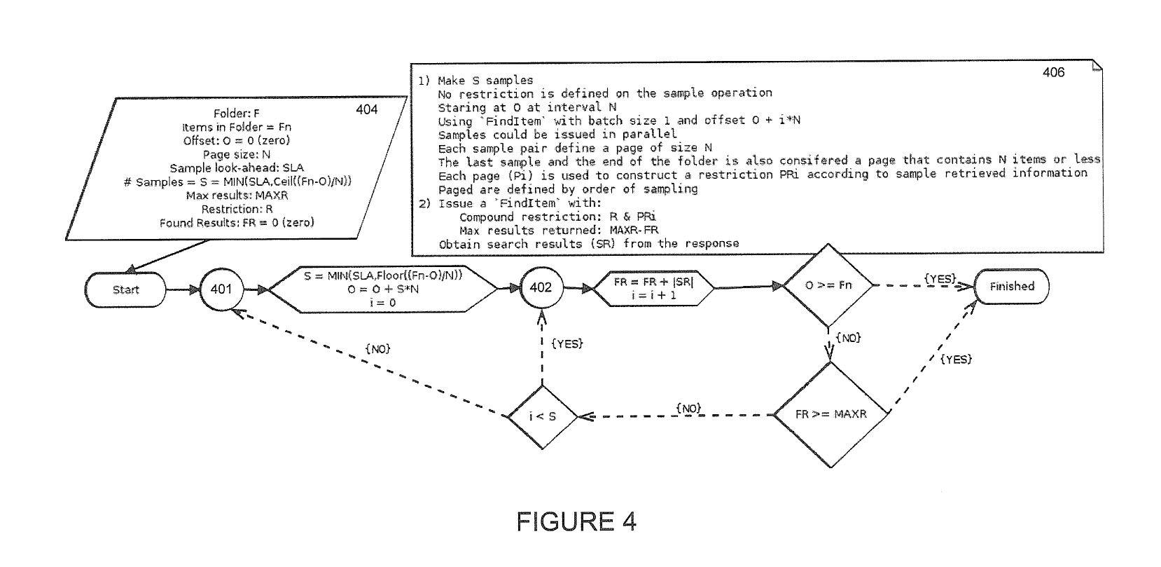

Refer now to FIG. 2, a flowchart of an embodiment of a method for optimized paged item loading in EWS and FIG. 3, a diagram of an exemplary implementation of FIG. 2. The general method of FIG. 2 and FIG. 3 is further described in FIG. 4, a first exemplary implementation of searching mail items. The notation used to help describe the general method of FIGS. 2 and 3 is consistent with the notation of the specific example of FIG. 4, however the values assigned may differ. The method is typically implemented by processes on the client 22 and Exchange server 34. Elements of the environment 60 from FIG. 1 are also referenced in this section of the current description. The methods of the flow diagram of FIG. 2 are typically performed automatically, but may be performed manually if desired.

Referring to block 200, the innovative method of optimized paged item loading in EWS begins with generating and sending at least one request (shown as first requests 101) from a component on client 22 sent from client 22 via gateway 30 and Exchange proxy 40 to EWS 52 on Exchange server 34. In the current non-limiting example, 5 (five) first requests are used. How many first requests are sent determines how many requests will be processed on the server and how many corresponding samples (results of processing) will be returned to the client 22. Each of the first requests 101 includes sufficient information for satisfying the request. In the current example, first request 101 includes which folder to search (typically a folder name, or designator indicating which folder to search, for example, e-mail 22B), and the sample item's number (for example, 1000). Typically, each first request is a FindItem command.

At block 202, first requests 101 are received for processing by the current method. In the current example, folder F is an e-mail inbox corresponding to the e-mail component 22B with e-mails. Folder F is sampled in S samples for every Nth item (sample size of N, in the current example 1000). In other words, each first request corresponds to sample Si of the S samples is taken from location N*i. The initiation of the processing of the first requests, also referred to as sampling, may be performed automatically or manually. In the current example, S and N are both integers, whereby S=5 samples S1 to S5 are taken with the N=1000 Nth item being the 1000th item. Typically, the samples are taken in parallel. In this example, the 5 samples S are taken in parallel. Accordingly, there are five consecutive samples, S1 to S5, each of the 1000^{th} item. In the current example, sample Si is item 1000, sample S2 is item 2000, etc. as shown in FIG. 3 sampling—first set 301. In the current example, the items are e-mails. Typically, the number of samples S is greater than 1, resulting in a plurality of samples being taken in parallel, thus improving performance and optimizing the initial sampling, as compared to conventional implementations. In certain cases, there may be a desire or requirement for sampling serially, in which case S can be set to 1, and only one sample is taken at a time.

After sampling, the samples 102 are returned from EWS 52 to client 22, and the method moves to block 204, where S restricted pages are defined according to each of the S samples. As S=5 in the current example, there are 5 pages, page-1 to page-5, (respectively deriving from samples S1 to S5) each page providing some restriction of 1000 items, as shown in FIG. 3 define pages—first set 311. Note that restricted pages are not physical pages containing N items of data, rather each page is an additional generic restriction to be sent from the client to the server in a second request.

After at least one page has been defined, the method moves to block 205, where requests (shown as second requests 104) are generated and sequentially sent from client 22 to EWS 52.

The method moves to block 206 where the received second request is processed (examined) by the EWS 52 according to the associated restrictions. Each second request includes restrictions of a page and search criteria. The section of the folder corresponding to the restricted page is then examined for results, generally searching for the search criteria (designated as R, in the current example “John.Doe@gmail.com”) in each item of the restricted page. The page examinations are typically performed consecutively, based on results obtained, as detailed below. In the current example, a first of the second requests 104 is processed, corresponding to the first restricted page, page-1 being examined. After examination, results of the processing are sent from the EWS 52 and received by the client 22. Results are designated as “SR”, and the number of results is designated as “|SR|”. For the current example, we will assume the number of results (found items) |SR| to be 18. In general, a second request is a second operation in which another FindItem operation is performed, with requested restrictions including a restricted page and search criteria. An empty search criteria restriction can be used to return all items within a sampled page. In other words, a second FindItem is issued with a compound restriction of page (Page-1) and search criteria (R).

After a page has been examined (in this example Page-1), the results 106 (SR) are sent from EWS 52 to client 22, and the method moves to block 208 where checking is done to see if the desired total number of results (in the current example, MAXR=25) has been obtained from the pages that have been examined. This checking allows a client to return a limited number of results to a requesting component. For example, in a case where the component is on a client with limited resources, or known usage is to only consider a limited number of results, there is only a need to return a limited number of results. If the maximum number of results is obtained from processing the first of the second requests (first restricted page), no further second requests need to be sent from the client to the EWS. Similarly, as soon as receiving a second request results in the total number of results being at least the desired maximum number of results, no further second requests need to be sent. In the current example, page-1 is the first restricted page being examined, so the total results (designated as “FR”, initially set to zero, FR=0) are the results from examining the first page (in the current example 18), so FR=FR+|SR|=0+18=18. A comparison is made to see if the total number of results FR is equal to or greater than the desired total results MAXR. If YES, the desired total number of results has been obtained from the review of the consecutive pages, the method moves to block 220, where the method ends.

If NO at block 208, the total number of results has not been obtained from the review of the consecutive pages, the method moves to block 210. In the current example, the maximum number of results to return to the client is 25 (MAXR=25), while only 18 results have been obtained (FR=18), so the method moves to block 210.

At block 210, a determination is made if there are more pages to be examined in the current set of samples, in other words, in the S pages (in the current example, of the 5 pages). IF, NO at block 210, there are no more pages of the S pages to be reviewed, the method moves to block 212. If YES, at block 210, there are more pages in the S pages to be reviewed, the method moves to block 205. In the current example, there are a total of 5 pages, and only 1 page has been reviewed, so the method moves to block 205 where the next second request (including a next page, in this case page-2 is sent and the method continues from block 206. In other words, the pages are examined iteratively when returning from block 210 to block 205, testing the condition described in block 208 each time.

At block 212, a determination is made if there are more samples that can be taken of the folder. In the current example, if all 5 pages (S=5) have been examined and less than the maximum number of results (FR<MAXR) have been found, then the method enters this step 212. If NO, more samples cannot be taken of the folder, the method moves to block 220, where the method ends. If YES, more samples can be taken from the folder, the method moves to block 214.

At block 214, additional first requests are generated to sample the folder (F) in another S samples for every Nth item from the Sth sample. In other words, continuing from where the previous sampling ended, and sampling the next sample. In the current example, S=5 and five more samples, hence five more pages are desired. Thus, the method moves (returns) to block 202 and samples S6 to S10 will be taken in a manner similar to that of block 202, as detailed above in reference to FIG. 2. Continuing to refer also to FIG. 3, sample S6 would begin after S5 and subsequent samples continue through S10. As described above, in the current example each sample is of 1000 items so sample S6 is item 6000, and so forth, shown as sampling—second set 302. As described above, the method then moves to block 204, where new pages are defined for the new samples, in the current example, corresponding page-6 to page-10, define pages—second set 312. The method then repeats from block 205 until a suitable number of results have been found, or all possible pages have been exhausted.

In the example of FIG. 3, should there not be enough results, with no more pages, but more items in the folder available, from sample S10, another set of first requests would be generated in step 214. In the current example, there are not enough items in the folder for a complete set of samples to be taken. Specifically, a complete set of samples is 5000 items (N*S=1000*5=5000), however there are only 10047 items in the folder. In this case, a partial set of first requests is generated (partial set of samples will be taken) to include all of the remaining items, shown as sampling—third set 303. In the current example, a single first request and corresponding single sample, sample S11, is taken, which has a restricted page of less than 1000 items, in this case bounding the restricted page to 47 items, items 10001 to 10047. Sample S11 is defined as page-11 (in step 204, shown as define pages—third set 313) and processed from block 205, with the processing of page-11 ending the cycle for the 10047 items in the current exemplary folder.

At block 220, when the method ends, the total cumulative results SR are returned to the component on client 22 as returned data. Alternatively, results can be returned to the requesting component as the results are received at the client, without waiting for the total results.

Referring to FIG. 4, a non-limiting first exemplary implementation of searching mail items. As described above, conventional use of FindItem to search for items, for example mail items with “John Doe” as the sender, will search the entire mail folder that may take a very long time until first results are returned (if results are retuned at all). In the current exemplary implementation, variables are defined in block 404, including:
RI—recovered information in samples
PRI—pages according to recovered information
R—restriction requirement
N—sample/page size
MAXR—number of results required.
SR—search results.
   |SR|—number of search results.

The functions shown in blocks (circles) 401 and 402 are respectively described in detail in block 406 sections 1 and 2.

The specific method described above in reference to FIG. 2 can also be represented as the following pseudo-code algorithm:

Do {

RI = Sample X times using N
Use PRi to issue out FindItem(s) to search within pages according to
R

} While total number of results < MAXR or EOF (Folder) reached

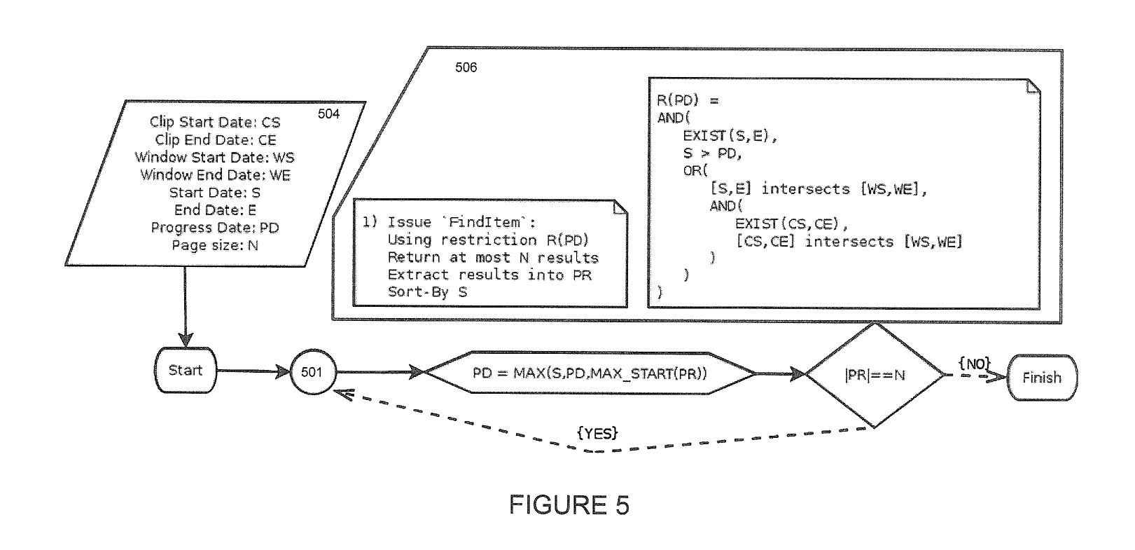

Referring to FIG. 5, a non-limiting second exemplary implementation of searching calendar items. The above-described method for optimized paged item loading in EWS can be applied similarly to locating calendar items in a calendar folder. As described above, conventional use of FindItem can be used for calendar paging. In particular, for calendars, EWS's FindItem provides the CalendarView element. The CalendarView element is not suitable for large data set paged queries for reasons including:
CalendarView is limited to a two-year window.
Recurring items, e.g., recurring meetings are not returned as master items, but rather the specific occurrences.
Restriction element cannot be used with CalendarView.

Applying the above-described general method of optimized paged item loading to the specific problem of calendar items features:
Using FindItem to locate all CalendarItems in the Calendar folder.
Paged loading according to date, and not number of items.

As calendar information is processed, there is a requirement to produce information (results) limited to a specific time span, typically spanning from ‘StartDate’ to ‘EndDate’). An issue that arises is that recurring meetings might intersect this time span but their ‘StartDate’ and ‘EndDate’ properties are the dates of their first occurrence corresponding properties. However, recurring meetings have the properties of ‘ClipStartDate’ and ‘ClipEndDate’ that describe the recurrence time span. Using ‘ClipStartDate’ and ‘ClipEndDate’, a time span (window) can be defined that is of interest for processing calendar events. Then paging can be used, the paging restricted to the newly defined window, and using the ‘StartDate’ property as a paging progress marker.

This innovative calendar loading method will result in all items intersecting the desired time frame, and will return the recurring-master meetings that will allow dealing with recurring meetings. This method of paged loading is intentionally used. While this method of paged loading does not return occurrences of recurring meetings, one skilled in the art will be able to use this method to derive occurrences from the recurring-master.

In the current exemplary implementation, variables are defined in block 504, including:
CS is ClipStartDate
CE is ClipEndDate
WS is window start date
WE is window end date
S is start date
E is end date
PD is progress date
N is page size

The function shown in block (circle) 501 is described in detail in block 506.

The method described above in reference to FIG. 2 can implemented for the specific case of calendar paging using a window restriction:

Window(S,E,CS,CE, date)
And

Exist S&E
Or

[S,E] intersects [WS,WE]
And

Exists CS & CE
[CS, CE] intersects [WS, WE]

S > date

Sort-By: S

and can be represented as the following pseudo-code algorithm:

Do {

R = Get N results intersecting Window(S,E,CS,CE,progressDate)
progressDate = MAX(StartDate,R)

} while (|R| == N)

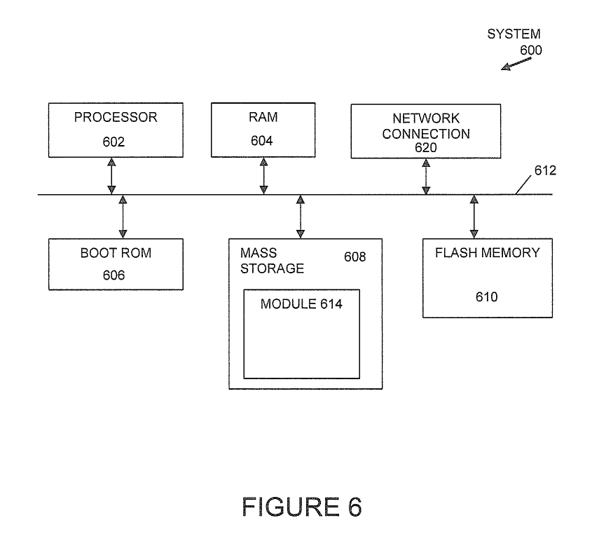

FIG. 6 is a high-level partial block diagram of an exemplary system 600 configured to implement client 22 or Exchange server 34 of the present invention. System (processing system) 600 includes a processor 602 (one or more) and four memory devices: a RAM 604, a boot ROM 606, a mass storage device (hard disk) 608, and a flash memory 610, all communicating via a common bus 612. A module (processing module) 614 is shown on mass storage 608, but as will be obvious to one skilled in the art, could be located on any of the memory devices.

Mass storage device 608 is a non-limiting example of a computer-readable storage medium bearing computer-readable code for implementing the methodology described herein. Other examples of such computer-readable storage media include read-only memories such as CDs bearing such code.

System 600 may have an operating system stored on the memory devices, the ROM may include boot code for the system, and the processor may be configured for executing the boot code to load the operating system to RAM 604, executing the operating system to copy computer-readable code to RAM 604 and execute the code.

Network connection 620 provides communications to and from system 600. Typically, a single network connection provides one or more links, including virtual connections, to other devices on local and/or remote networks. Alternatively, system 600 can include more than one network connection (not shown), each network connection providing one or more links to other devices and/or networks.

System 600 can be implemented as a server or client respectively connected through a network to a client or server.

Note that a variety of implementations for modules and processing are possible, depending on the application. Modules are preferably implemented in software, but can also be implemented in hardware and firmware, on a single processor or distributed processors, at one or more locations. The above-described module functions can be combined and implemented as fewer modules or separated into sub-functions and implemented as a larger number of modules. Based on the above description, one skilled in the art will be able to design an implementation for a specific application.

The above-described method and processes including portions thereof can be performed by software, hardware, and combinations thereof. These methods and portions thereof can be performed by computers, computer-type devices, workstations, processors, microprocessors, other electronic searching tools and memory and other storage-type devices associated therewith. The methods and portions thereof can also be embodied in non-transitory storage devices, for example, programmable storage devices such as compact discs (CDs) or other discs including magnetic, optical, etc., readable by a machine or the like, or other computer usable storage media, including magnetic, optical, or semiconductor storage, or other source of non-transient electronic signals.

Note that the above-described examples, numbers used, and exemplary calculations are to assist in the description of this embodiment. Inadvertent typographical errors, mathematical errors, and/or the use of simplified calculations do not detract from the utility and basic advantages of the invention.

To the extent that the appended claims have been drafted without multiple dependencies, this has been done only to accommodate formal requirements in jurisdictions that do not allow such multiple dependencies. It should be noted that all possible combinations of features that would be implied by rendering the claims multiply dependent are explicitly envisaged and should be considered part of the invention.

It will be appreciated that the above descriptions are intended only to serve as examples, and that many other embodiments are possible within the scope of the present invention as defined in the appended claims.

What is claimed is:

1. A method for searching an Exchange Web Services (EWS) server, comprising the steps of:
(a) sending at least one first request to the EWS, each said first request including a designator to a corresponding folder and a sample item;
(b) receiving at least one sample, each said sample corresponding to each said first request;
(c) defining at least one restricted page, each said restricted page corresponding to each said sample;
(d) sending at least one second request to the EWS, each said second request: corresponding to each said sample, including said restricted page, and including a search criteria; and
(e) receiving results for each said second request.

2. The method of claim 1 wherein said sending is done using a FindItem command.

3. The method of claim 1 wherein said sending to the EWS said at least one second request is sequential.

4. The method of claim 3 wherein after said sending to the EWS said at least one second request, a decision to send to the EWS a subsequent second request is based on said receiving results.

5. The method of claim 4 further comprising a step of:
(f) checking if a total number of received results is greater than or equal to a desired number of results:
(i) if yes, returning all said results; and
(ii) if no, checking if more of said at least one second request has not been sent to the EWS:
(A) if yes, sending to the EWS a subsequent second request of said at least one second request and continuing at step claim (1)(e); and
(B) if no, checking if more first requests can be sent to the EWS:
(I) if no, returning all said results; and
(II) if yes, sending at least one new first request to the EWS and continuing at step claim (1) (b).

6. A system comprising: a client configured for:
(a) sending at least one first request to an Exchange Web Services (EWS), each said first request including a designator to a corresponding folder and a sample item;
(b) receiving at least one sample, each said sample corresponding to each said first request;
(c) defining at least one restricted page, each said restricted page corresponding to each said sample;
(d) sending at least one second request to the EWS, each said second request: corresponding to each said sample, including said restricted page, and including a search criteria; and
(e) receiving results for each said second request.

7. The system of claim 6 wherein said client is further configured to perform said sending using a FindItem command.

8. The system of claim 6 wherein said client is further configured to perform said sending at least one second request to the EWS sequentially.

9. The system of claim 8 wherein said client is further configured that after said sending to the EWS said at least one second request, a decision to send to the EWS a subsequent second request is based on said receiving results.

10. The system of claim 9 wherein said client is further configured for:
(f) checking if a total number of received results is greater than or equal to a desired number of results:
(i) if yes, returning all said results; and
(ii) if no, checking if more of said at least one second request has not been sent to the EWS:
(A) if yes, sending to the EWS a subsequent second request of said at least one second request and continuing at step claim (6)(e); and
(B) if no, checking if more first requests can be sent to the EWS:
(I) if no, returning all said results; and
(II) if yes, sending at least one new first request to the EWS and continuing at step claim (6) (b).

11. A computer-readable storage medium having embedded thereon computer-readable code for searching an Exchange Web Services (EWS) server, the computer-readable code comprising program code for:
(a) sending at least one first request to the EWS, each said first request including a designator to a corresponding folder and a sample item;
(b) receiving at least one sample, each said sample corresponding to each said first request;
(c) defining at least one restricted page, each said restricted page corresponding to each said sample;
(d) sending at least one second request to the EWS, each said second request: corresponding to each said sample, including said restricted page, and including a search criteria; and
(e) receiving results for each said second request.
